(19) United States
(12) Patent Application Publication
(10) Pub. No.: US 2002/0138425 A1
(43) Pub. Date: Sep. 26, 2002

(54) Electronic payment system and method for electronic payment

(76) Inventors: Atsushi Shimizu, Shimogyo-ku (JP); Yasuyuki Hirakawa, Shimogyo-ku (JP); Noriaki Kaneda, Shimogyo-ku (JP)

Correspondence Address: ROSENTHAL & OSHA L.L.P., 1221 MCKINNEY AVENUE, SUITE 2800, HOUSTON, TX, 77010, US

(21) Appl. No.: 10/004,282

(22) Filed: Oct. 22, 2001

(30) Foreign Application Priority Data
Oct. 20, 2000 (JP) 2000-321445

(51) Int. Cl. G06F 17/60

(52) U.S. Cl. 705/40; 705/39

(57) ABSTRACT

The electronic settlement system of the present invention is an electronic settlement system for the purpose of paying a plurality of expenses requested by the user within a predetermined time period using electronic settlement. It consists of a cash-deposit processing means, which processes cash deposits for each of the expense categories, a payment processing means that makes payments for each of the expense categories, as well as a memory which can store the payment method, payment period, scheduled payment amount and available credit information for each of the expense categories, spreadsheet management of payments and deposits made by the user in each of the categories using electronic settlement and a spreadsheet management means that sends notices to the user on a regular basis. Preferably, the above-mentioned memory will include an available credit correction means that can correct the content of the available credit contained in memory. Furthermore, in the event that the expense category requested for which electronic settlement has been requested is deductible under the tax laws, it would be preferable to have a detail of the deposit and payment amounts that occurred during the fiscal year printed out in a format that could be used in the payment of taxes from the above spreadsheet management means at the end of the corresponding fiscal year.

### BACKGROUND OF INVENTION

This invention relates to a method of electronic transaction settlement and electronic transaction settlement systems used for settling transactions electronically.

In processes where corporations conduct business, many types of expenses are generated and, in recent times, electronic settlement has been used more frequently as a means of settling payments. The conventional methods for settling accounts electronically can be divided into two large groups: credit transactions and prepaid transactions. Credit transaction is the method in which the credit card user is allowed a pre-set amount of credit based on earning potential and ability to pay. It allows delayed payment of amounts within a certain range. Prepaid transaction allows the use of amounts within a range already collected from the user. Electronic money is a type of prepaid transaction.

FIG. 1 is a block diagram showing conventional electronic settlement methods by means of the credit system. With this electronic settlement system, a user 2 signs a credit agreement with a credit card company 1 and the user 2 is issued a corporate card which is used in settling payment expenses. The employees of the user 2 can use said corporate card for the payment of company expenses. After the credit company has confirmed that the amount to be applied to the user's credit card is within the range of allowed credit, which was determined when the user signed the credit agreement, it pays the requested amount to a transaction party 3 at the transaction site. The amount that the credit card company 1 pays from its own resources is then collected by transferring the payment amount from a user's bank 4 account before the established credit deadline.

The above electronic settlement system using a corporate card allows the users to pay for all types of company expenses. All that needs to be done is to monitor the total payment expenses at the accounting stage on the company side.

Therefore, it is extremely convenient as a means of paying any of company's various expenses. However, while the card in question can be used to pay all manner of expenses, the accountant will have to divide them into tax-deductible expenses and non-deductible expenses, which means monitoring and categorizing them. This sort of account monitoring is a great burden particularly on smaller venture companies. Furthermore, the amount of credit extended by the agreement with credit card company 1 is influenced by the user's economic might. Therefore, companies like a small venture company can not avoid inconvenient treatment in terms of setting up credit amount or interest rate.

On the other hand, the above prepaid card system has a high degree of safety in a manner that a fixed amount of funds is paid in advance by the user, whose use stays within the limits of that amount. This is also convenient for accountants of companies who are in charge of monitoring and categorizing company expense payments. However, this system requires payment of funds when the prepaid card is issued, resulting in causing an adverse effect on a company's cash management. Furthermore, because it is a pre-paid system, it is inconvenient that the users can neither obtain credit nor use it beyond the amount paid in advance.

For the above mentioned reasons, what is needed is a system that maximizes credit to companies irrespective of size, makes monitoring and categorizing company expenses more effective and simplifies a company's filing of taxes.

### SUMMARY OF INVENTION

An embodiment of the electronic settlement system of the present invention is an electronic settlement system for electronically paying a plurality of expenses requested by a user within a predetermined period that comprises deposit processing means for processing a deposit for each of the plurality of expenses, payment processing means for processing a payment for each of the plurality of expenses, storage means for storing payment method, payment period, scheduled payment amount, and credit limit for each of the plurality of expenses, and management means for totalizing deposits and payments from a user through the electronic settlement system and informing the user of the totalized amount thereof for each of the plurality of expenses.

Preferably, an embodiment of the electronic settlement system of the present invention further comprises a credit limit alteration means for altering credit limit stored by the storage means in accordance with the difference between the total deposit amount and total payment amount that is calculated at a time when request of payment by the electronic payment system is received.

According to another preferable embodiment, the management means of the electronic settlement system prints out deposits and payments of that expense within a tax fiscal year at an end of that year on an accounting sheet in a manner that the accounting sheet can be used to submit to tax office if the expense requested to be paid by the electronic settlement system is subject to tax deduction.

An embodiment of the electronic settlement method of the present invention is an electronic settlement method for electronically paying a plurality of expenses requested by a user within a predetermined period that comprises storing payment method, payment period, scheduled payment amount, and credit limit of the expense that is requested to pay by the electronic settlement method for each of the plurality of expenses, storing a deposit data from a user for each of the plurality of expenses upon receiving a request to pay by the electronic settlement system, determining whether payment is allowed based on the stored data of deposit and credit limit for the expense, and paying the requested expense if payment to that request is determined to be allowable, and rejecting the payment if payment to that request is not allowable.

Preferably, an embodiment of the electronic settlement method further comprises calculating difference between total deposit amount and total payment amount at a time payment is requested to the electronic settlement system, altering credit limit stored in the system based on the difference, and determining whether payment is allowable to that request of payment to the electronic settlement system.

Preferably, the management means of the electronic settlement method according to an embodiment of the present invention prints out deposits and payments of that expense within a tax fiscal year at an end of that year on an accounting sheet in a manner that the accounting sheet can be used to submit to tax office if the expense requested to be paid by the electronic settlement system is subject to tax deduction.

According to the electronic settlement system of the present invention, the party who renders services of the electronic settlement system receives deposits for paying the expenses in lump sum or installments, and pays the received amount in accordance with the predetermined method and instruction from the user. This is almost as if the user of this electronic settlement system of the present invention is using this system almost as his/her wallet. This system is very convenient for the user in that upon terminating the trust period, the excess or shortage of the deposit is calculated and the result of such calculation is printed out for the user.

### BRIEF DESCRIPTION OF DRAWINGS

FIG. 1 is a block diagram showing the electronic settlement method using a prior art.

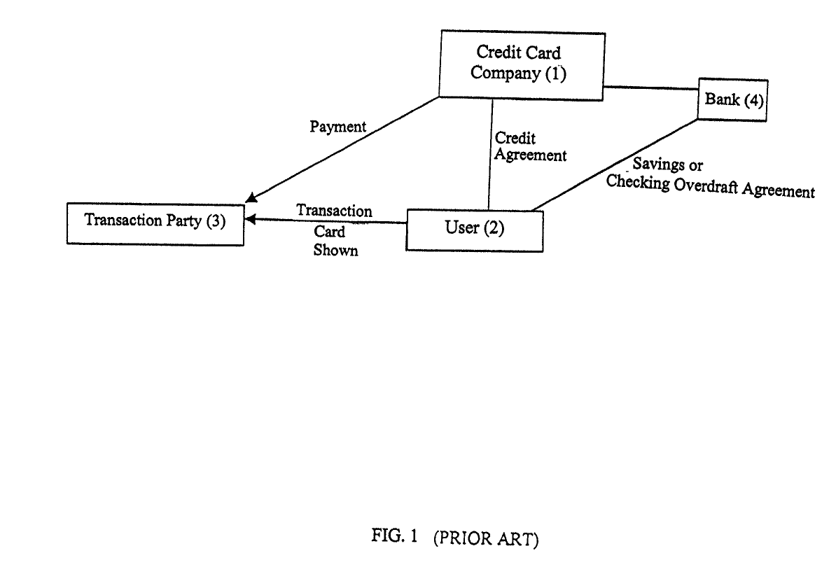

FIG. 2 is a block diagram showing the electronic settlement method of the present invention.

FIG. 3 is a block diagram showing the electronic settlement system of the present invention.

FIG. 4 is a table showing the payment amount for each corporate expense category, payment range, payment amount, scheduled payment period and other features using the electronic settlement system of the present invention.

FIG. 5 is a flow chart showing the specific procedures for settling a user's special expenses using the electronic settlement system of the present invention.

### DETAILED DESCRIPTION

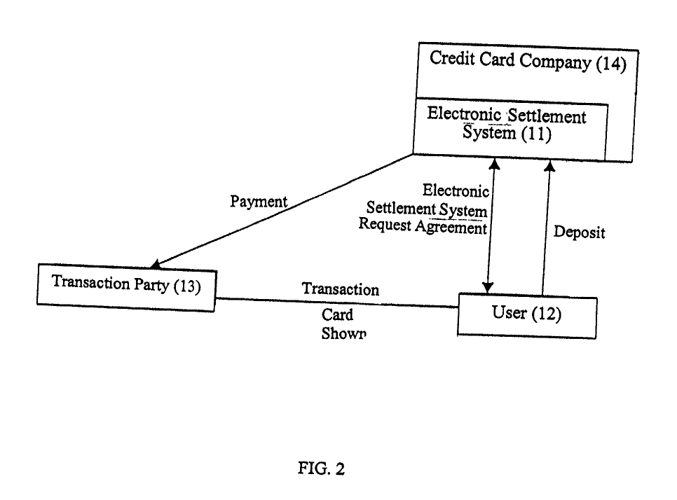

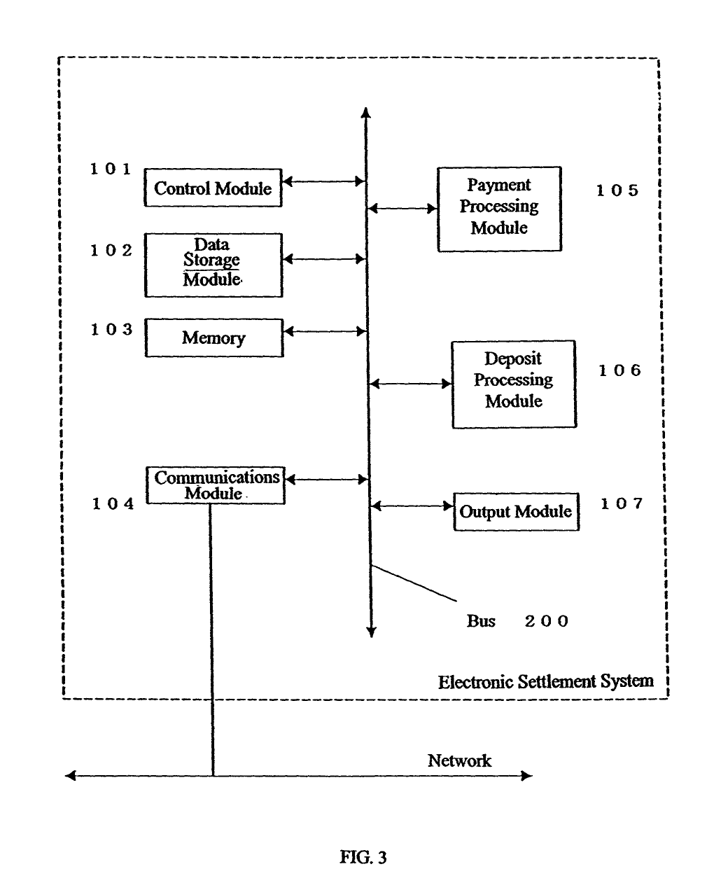

The embodiments of the present invention are explained below with reference to FIG. 2 through FIG. 5. FIG. 2 shows the method of settling accounts using the electronic settlement system 11 of the present invention. FIG. 3 is a configuration of the electronic settlement system 11 of the present invention.

As exemplarily shown in FIG. 3, the electronic settlement system 11 of the present invention includes a control module 101, a data storage module 102, a memory 103, a communications module 104, a payment processing module 105, a deposit processing module 106, and an output module 107. These are connected to each other by means of a bus 200.

The control module 101 controls the entire electronic settlement system 11 and controls the execution of each of the various processings. The data storage module 102 stores the data of the electronic settlement available credit details determined in the agreement between the user 12 and the credit card company 14, subsequent deposit, payment and other transaction data produced based on the electronic settlement request, as well as the programs for processing deposits and payment in a manner that those data thus stored can be read out therefrom or written thereto. The memory 103 includes ROM and RAM, and stores data and programs that are necessary for operating the electronic settlement system 1 in a manner that they can be read out therefrom, and also temporarily stores the data which is read out from the data storage module 102 for data processing.

The communications module 104 is connected to an external network by means of a communications line and transmits data to the transaction party 13, financial institution or other source pertaining to the electronic transaction using this electronic settlement system 11. The payment processing module 105 receives the payment request or other data sent from the transaction party 13 through the communications module 103 over the bus 20 and performs the necessary processing. Then, the payment processing module 105 transmits this data to the control module 101 over the bus 20. The payment processing module 105 receives the result of this processing and confirms that the conditions for paying the requested amount have been satisfied before carrying out the processing necessary for paying to the transaction party 13. When there is a payment of this sort, this payment data is sent to the data storage module 103 through the bus 20 and is stored therein. When there has been a deposit from the user 12, the deposit processing module 106 processes that deposit information and transmits it to the control module 101 through the bus 20. This deposit information is then sent from the control module 101 to the data storage module 102 and is stored in memory. The output module 107 outputs to the display device data such as deposit or withdrawal information using this electronic settlement system 11 and prints it out on various types of forms.

FIG. 2 is a block diagram showing the method for electronically settling user's specific expenses using this electronic settlement system 11. To receive electronic settlement service using this electronic settlement system 11, the user 12 first concludes an electronic settlement payment management trust agreement with the credit card company 14 providing the service using this electronic settlement system 11 to determine such matters as the expense categories covered, conditions, deposit schedule. The expense categories, conditions, deposit schedule and other matters which have been determined at this point are all stored in the data storage module 102 of the electronic settlement system 11. After concluding the agreement with the credit card company 14, the user is issued a credit card (corporate card) that will be used with this electronic settlement system 11.

The credit card company 14 pays the transaction party 13 the specific expenses which the user 12 requested to pay through this electronic settlement system 11 by using the method determined in advance in the agreement. More specifically, the credit card company 14 transfers funds as payment through this electronic settlement system 11 to the bank account of the transaction party 13 designated by the user 12. Or, the credit card company 14 makes payments on individual requests made using the corporate card issued by the credit card company 14 within the range of available deposit or credit using the electronic settlement system 1. The user 12 deposits the funds necessary for making payments to the credit card company 14 using the electronic settlement system according to the deposit schedule determined in the electronic settlement management request agreement concluded with the credit card company 14. The deposit methods may include having the user make deposits through this electronic settlement system 11 into the bank account designated by the credit card company 14 or having the electronic settlement system 11 withdraw the payment amount from the bank account of the user 12.

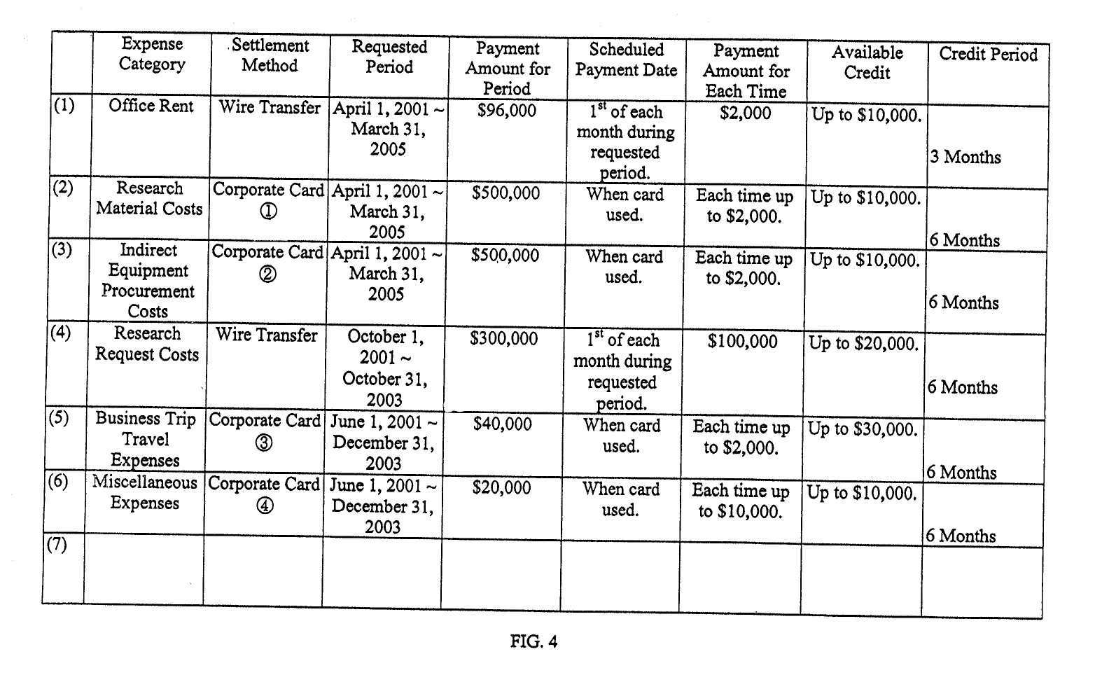

FIG. 4 shows an example of a table (electronic settlement trust detailed table) which summarizes the payment range, the payment amount, the scheduled payment period and other information for each expense category of the company using the electronic settlement system of the present invention. This data is all stored with other necessary data such as the deposit schedule in the data storage module 102 of this electronic settlement system 11. First, the user 12 designates expense categories desired to receive the electronic settlement services of this system. By classifying and identifying the various expenses generated through the operation of a company depending on the nature of each of such expenses and determining conditions and methods, etc. of electronic settlement in this manner, it becomes possible to extend reasonable and maximized amount of available credit and the credit period depending on the nature or content of each expense. In the electronic settlement table shown in FIG. 4, the user 12 has designated “Office Rent” (1), “Research Material Costs” (2), “Indirect Equipment Procurement” (3), “Research Request Costs” (4), “Business Trip Travel Expenses” (5) and “Miscellaneous Expenses” (6) as the expenses desired to receive the service using this electronic settlement system 11. Naturally it is possible to add to these expense categories later, as necessary.

Of these, the “Office Rent” (1) is a fixed tenant fee ($2,000) paid every month during the period that the office space is to be leased by the user (Apr. 1, 2001˜Mar. 31, 2005). The “Research Material Costs” (2) is the expenses for purchasing the equipment and materials for use in research and development experiments by the employees of the user's company. The “Indirect Equipment Procurement” (3) is the cost of materials that are sold externally for an equivalent amount. If the user were, for example, a venture business for developing a technology, they might outsource a portion of the development of their technology through a specific research organization. The “Research Request Costs” (4) is the expenses paid for and equivalent amount of research projects and reports submitted by that research organization. The “Business Trip Travel Expenses” (5) is expenses generated when employees of the user are travelling on business. The “Miscellaneous Expenses” (6) is other expenses expected to be spent by the user for conducting business and is not a part of the aforementioned business travel expenses. For example, this includes entertainment or the purchase of office supplies. Of these expenses, the “Office Rent” (1), the “Research Material Costs” (2), the “Research Request Expenses” (4) and the“Business Trip Travel Expenses” (5) are all deductible amounts under the tax law. The “Indirect Equipment Expenses” (3) is not be deductible. The “Miscellaneous Expenses” (6) includes various types of expenses, so there are some that are deductible and others that are not deductible.

The method for paying these expenses is determined in the electronic settlement request agreement described above. In the example shown in FIG. 4, the “Office Rent” (1) is paid by the user 2 into the bank account of the real estate agent (landlord) leasing the office space on the first of every month by transferring the funds electronically from the electronic settlement system 11. The “Research Request Costs” (4) is paid into the bank account of the research organization at the end of every month by transferring the funds electronically from the electronic settlement system 11. Payment of the “Research Material Costs” (2), the “Indirect Equipment Procurement” (3), the “Business Trip Travel Expenses” (5) and the “Miscellaneous Expenses” (6) are made using the corporate card (credit card) issued by the credit company in the above electronic settlement request agreement. Here, the corporate card \mathring{1} is used for the “Research Material Costs” (2), the corporate card \mathring{2} is used for the “Indirect Equipment Procurement” (3), the corporate card \mathring{3} is used for the “Business Trip Travel Expenses” (5) and the corporate card \mathring{4} is used for the “Miscellaneous Expenses.” Naturally, it is possible to use some sort of means for distinguishing among these so that they could all be settled using the same card without requiring the use of separate cards. The transaction party 13 which which carried out the transaction using the corporate card asks for the amount of the payment paid with the corporate card and receives payment from the credit card company 14. In this case, the amount per transaction is unfixed and can be different with each transaction. However, it is possible to set the amount so that it will be below a certain pre-determined limit each time. In the example shown in FIG. 3, the “Research Material Costs” (2) and the “Indirect Equipment Procurement” have been set to a $5,000 per-time maximum, the “Business Trip Travel expenses” has been set to a maximum of $30,000 per time, and the “Miscellaneous Expenses” (6) has been set to a $10,000 per-time maximum.

Determining Available Credit and Credit Periods

According to this electronic settlement system 11, available credit limit amount and credit period are determined for each individual expense above based on such data as the electronic settlement request period, total scheduled payment and the scheduled payment amounts for each payment. Here, the credit amount is the maximum limit amount that the service company can pay the expense of the user beyond the deposit amount when the amount of credit goes negative due to the subtraction of expense payments by the service company from the amount on deposit from the user. The credit period is the grace period granted to the user, during which funds are to be deposited to cover non-sufficient funds by the user when payments made within the available credit limit amount exceed the deposit amount. The user 12 is to pay to the credit card company 14 an amount of interest determined in advance, corresponding to the period until the amount of the difference has been paid off.

The credit card company 14 decides in advance the rules for determining the conditions for granting credit to the user 12 and that data can be stored in memory in the electronic settlement system 1. This makes it possible for the electronic settlement system 1 to determine the conditions and type of credit for each of the expense categories requested by the user of the electronic settlement in question for electronic settlement by applying the rules in question and making the relevant calculations when as the user requests electronic settlement.

In this way, all of the different types of company expenses that require credit for payment can be categorized by content and, by deciding the amount of credit and the credit period for the individual types. By doing so, even a small venture company is able to maximize in a rational manner the amount of credit available in relation to the risk. Upon determination of the amount of credit and the credit period in addition to the above data, as conventionally, the amount of credit to be awarded can be naturally based on an advance evaluation of the user's economic capacity and that evaluation can be used in the determination of the available credit along with the other data used to determine the available credit and the credit period. By taking into account the economic capacity and credibility of the user's company, it becomes possible to make the determination of credit details based on this system more rational.

As described above, as a rule, the credit granted for the users in this electronic settlement system is based on the payment request period, the scheduled total payment, the scheduled payment period, etc. of the expenses in question for each of the individual expenses for which electronic settlement payment has been requested. The amount of available credit is treated as a processing of the difference between the payment amount and the deposit amount for the individual expenses. This is true for the credit allowed, and it However, as shown in FIG. 4, when the user requests several expense payments simultaneously, the deposit amount for one expense category may be lower than the payment amount (which would make it available as credit), but taking as a total, all of the expense categories for which a settlement request has been received, the amount on deposit will still be higher than the total amount to be paid. In this situation, it becomes possible to adjust the settings so that the excess available amount of credit would apply to all of the expense categories for which a settlement request had been received and used for the insufficient deposit amounts in other expense categories. By setting it up in this way, it becomes possible to set up the conditions of available credit and credit period for individual expenses so that they will be more advantageous to the user.

Conversely to the above, if the payment amount were to exceed the deposit amount for a particular expense category, even when the difference is still within the amount of available credit, it can be set up to refuse payment when the payment request is sent to the electronic settlement system 11, by reducing the available credit determined in advance for the expense category in question when the total amount of funds on deposit is not enough to cover the total amount to be paid and there are insufficient funds in excess of the pre-determined amount. Setting things up in this way may appear to be a disadvantage to the user at first glance, but conversely, conditions of this sort can also allow fuller use of the range of available credit in individual expense categories.

When determining available credit based on the electronic settlement system 11, it is possible to set a greater margin of available credit by evaluating the tax deductibility of an expense category of the electronic settlement system 11 as a plus factor in the user's economic capacity or ability to pay. More specifically, for example, the Office Rent, the Research Request Costs and the Business Travel Costs in FIG. 3 are all costs that can be claimed for tax deductions, so the range of available credit for the payment of those expenses can be greater than the range of credit allowed for the expense categories that are not tax deductible. Specifically how much greater to set them will depend on a quantitative judgment made by the credit company providing the service using this electronic settlement system. However, for example, it is conceivable that the margin of credit on expenses that are tax deductible can set to a uniform 5% increase. By distinguishing tax-deductible expense categories from non-tax-deductible categories it becomes possible to grant a greater amount of credit to a user requesting this electronic settlement system for expenses that are tax deductible. For a venture company that is trying to develop special, new types of technology, this sort of handling is extremely advantageous because it allows research and development costs to receive tax deduction.

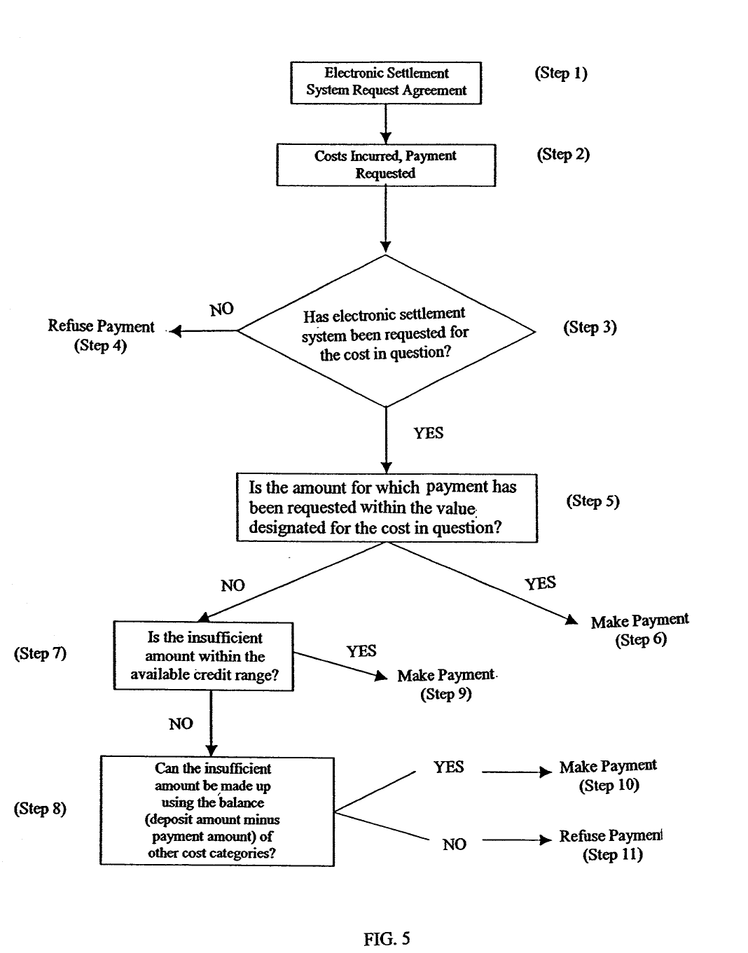

FIG. 5 is a flowchart showing the specific procedure for settling specific expenses of the user 12 using the electronic settlement system of the present invention. First, the user 12, who wishes to use the electronic settlement system of the present invention, concludes an electronic settlement request agreement with the credit card company 14. (Step 1) Next, as particular costs are generated by the user and there is a request for payment (Step 2), this electronic settlement system determines whether or not that cost is one for which payment has been requested. (Step 3) If it has not been requested, the electronic settlement system will not consider it eligible for payment. Therefore, even if the transaction party 13, for example, requests payment of the electronic settlement system 11, payment will be refused. (Step 4) If it is an expense for which electronic settlement has been requested, then the amount on deposit from the user 12 at that time will be checked for the expense in question and to determine whether or not the amount of the payment request is within the range of the amount deposited. (Step 5) As a result, if the expense in question is within the range of the funds on deposit, such expense will be paid from the electronic settlement system 1. (Step 6) If it is in excess of the amount of funds on deposit, then the system will check if the shortfall is within the range of available credit. (Step 7) As a result, if it is within the range of available credit, payment will be made (Step 9) If it exceeds the amount of available credit, the system will check if there are sufficient funds to offset the shortfall in the balance of the total funds on deposit in other categories. (Step 8) If there are, payment will be made. (Step 10) If there are not sufficient funds, payment will be refused. (Step 11)

Management Spreadsheet Service

In addition to the above credit services, for each of the requested expenses, the electronic settlement system 1 can also manage detailed payment spreadsheets for the request period and provide them to the user. The user can know how much and into which categories to deposit each time by confirming the deposits and payment details as well as the cash payment balance sent from the electronic settlement system 11 within the request period. This allows the company to manage the payment of corporate expenses easily through this system and to omit a great deal of accounting work at the company. Additionally, at the end of the request period, it is possible to obtain a detailed statement of all of the expense payments to that point for each of the particular categories. Therefore, it is useful in processing the company's accounts.

Furthermore, by requesting the electronic settlement of expenses that are tax deductible using the electronic settlement system of the present invention, a payment detail can be obtained from this system for each of the expense categories requested. This is extremely convenient for corporations filing taxes. One way to use this electronic settlement system is to request all of the settlements of corporate expenses that are tax deductible and use the payment detail printed out and sent out from this electronic settlement system as documentation for claiming tax deductions. In this case, it is preferable to have the payment detail in question printed out in a format that can be used as a tax-deduction claim form without modification.

According to the electronic settlement system of the present invention, it determines the credit amount and period, the payment amount and the payment request period corresponding to the contents of expenses for each expense category designated by the user. Therefore, it becomes possible to determine the amount of available credit from elements other than the economic capacity/ability to pay off the use's company. As a result, it becomes an electronic settlement system that is easy to use for small venture companies.

What is claimed is:

1.] An electronic settlement system for electronically paying a plurality of expenses requested by a user within a predetermined period, comprising:
deposit processing means for processing a deposit for each of the plurality of expenses;
payment processing means for processing a payment for each of the plurality of expenses;
storage means for storing payment method, payment period, scheduled payment amount, and credit limit for each of the plurality of expenses; and
management means for totalizing deposits and payments from a user through the electronic settlement system and informing the user of the totalized amount thereof for each of the plurality of expenses.

2.] The electronic settlement system according to claim 1, further comprising a credit limit alteration means for altering credit limit stored by the storage means in accordance with the difference between the total deposit amount and total payment amount that is calculated at a time when request of payment by the electronic payment system is received.

3.] The electronic settlement system according to claim 1, wherein if the expense requested to be paid by the electronic settlement system is subject to tax deduction, the management means prints out deposits and payments of that expense within a tax fiscal year at an end of that year on an accounting sheet in a manner that the accounting sheet can be used to submit to tax office.

4.] An electronic settlement method for electronically paying a plurality of expenses requested by a user within a predetermined period, comprising:
storing payment method, payment period, scheduled payment amount, and credit limit of the expense that is requested to pay by the electronic settlement method for each of the plurality of expenses;
storing a deposit data from a user for each of the plurality of expenses;
upon receiving a request to pay by the electronic settlement system, determining whether payment is allowed based on the stored data of deposit and credit limit for the expense; and
paying the requested expense if payment to that request is determined to be allowable, and rejecting the payment if payment to that request is not allowable.

5.] The electronic settlement method according to claim 4, further comprising calculating difference between total deposit amount and total payment amount at a time payment is requested to the electronic settlement system, altering credit limit stored in the system based on the difference, and determining whether payment is allowable to that request of payment to the electronic settlement system.

6.] The electronic settlement method according to claim 4, wherein if the expense requested to be paid by the electronic settlement system is subject to tax deduction, printing out deposits and payments of that expense within a tax fiscal year at an end of that year on an accounting sheet in a manner that the accounting sheet can be used to submit to tax office.
